(19) United States
(12) Patent Application Publication
(10) Pub. No.: US 2021/0368799 A1
(43) Pub. Date: Dec. 2, 2021

(54) TERNARY INSECTICIDAL MIXTURE

(71) Applicant: Adama Makhteshim Ltd., Beer Sheva (IL)

(72) Inventors: Celio Hiroyuki FUDO, Londrina (BR); Yvan Cesar LOPES, Londrina (BR); Gerson Dalla Corte, Londrina (BR); Ernesto BENETTI, Londrina (BR)

(21) Appl. No.: 17/283,154

(22) PCT Filed: Oct. 7, 2019
(86) PCT No.: PCT/IL2019/051101

§ 371 Date: Apr. 6, 2021

Related U.S. Application Data
(60) Provisional application No. 62/742,371, filed on Oct. 7, 2018.

(51) Int. Cl. A01N 57/28; A01N 53/00; A01N 47/40

(52) U.S. Cl. CPC A01N 57/28; A01N 47/40; A01N 53/00

(57) ABSTRACT

The present invention relates to insecticidal mixtures comprising a) a pyrethroid compound, b) a neonicotinoid compound and c) an organophosphate compound.

### CROSS-REFERENCE TO RELATED APPLICATIONS

This application is a national stage filing under 35 U.S.C. § 371 of PCT/IL2019/051101, filed on Oct. 7, 2019 which claims priority to U.S. application Ser. No. 62/742,371 filed on Oct. 7, 2018. The applications are incorporated herein by reference in their entirety.

### FIELD AND BACKGROUND OF THE INVENTION

The present subject matter relates to a ternary insecticidal combination that comprises a combination of a) a pyrethroid compound, b) a neonicotinoid compound and c) an organophosphate compound, and to a method for controlling insect pests by using said combination.

The vulnerability of crops to pests makes pest control one of the major management components of the total crop production system. Insects are very destructive to crop plants and can significantly reduce crop yields and quality. Insecticides help minimize this damage by controlling insect pests. Many insecticidal agents and compositions are commercially available for these purposes.

The brown stink bug, (Euschistus heros) is one of the most abundant species, being considered one of the most important pest species occurring in Brazilian soybeans. The brown stink bugs feed directly on the pods of the soybean plant. Annually tons of grains are lost because of the brown stink bug.

The whitefly (Bemisia tabaci) used to be of secondary importance to soybean crops, but in recent years, in some states of Brazil, this species has become a key-pest, reducing yields. Nymphs and adults feed in soybean plant phloem and obtain sap containing various sugars. On soybean plants, the whitefly is the vector of a virus of the carlavirus group responsible for the disease called soybean stem necrosis. Soybean plants infected with this virus display necrosed stems, which as the symptoms progress may kill the entire plant.

The control of pests in soybean crop is carried out almost exclusively by the use of chemical insecticides. However, the continuous use of the same active ingredients, and the application of insecticides with a broad spectrum of application as a post-emergent insecticide may contribute to the increase the pest population and the emergence of resistant populations.

Combinations of insecticides are typically used to broaden spectrum of control, to minimize the doses of chemicals used, to retard resistance development and to reduce the cost of the treatment through additive effect. Although many combinations of insecticidal agents have been studied, a synergistic effect is rarely attained.

Further, the activity and selectivity behavior of any specific mixture is difficult to predict since the behavior of each single insecticide in the mixture is often affected by the presence of the other components and the activity of the mixture may also vary considerably depending on chemical character, plant species, growth stage, and environmental conditions. Mostly, this practice results in reduced activity of the insecticides in the mixture.

Practical agricultural experience has shown that the repeated and exclusive application of an individual active compound in the control of insect pests leads in many cases to a selection of those pests which have developed natural or adapted resistance against the active compound in question. Effective control of these pests with the active compound in question is then no longer possible.

In order to reduce the risk of insect pests becoming resistant to certain active compounds, mixtures of different active compounds are nowadays conventionally employed for controlling insect pests. By combining active compounds having different mechanisms of action, it is possible to ensure successful control over a relatively long period of time.

Pyrethroids are a class of insecticides that act in a manner similar to pyrethrins, which are derived from chrysanthemum flowers. These insecticides prolong the opening of the sodium channel, and produce instant paralysis. Pyrethroids are widely used for controlling various insects. Neonicotinoids are a class of insecticides which act on the central nervous system of insects, blocking an acetylcholine receptor. They are a class of synthetic compounds based on the naturally occurring compound nicotine. Neonicotinoids are among the most widely used insecticides worldwide.

Organophosphates are a class of insecticides which act on the enzyme acetylcholinesterase. These insecticides inhibit this neuromuscular enzyme, which is broadly essential for normal function in insects, leading to overstimulation and dysfunction of the nervous system.

A synergistic insecticidal composition comprising a chloronicotinyl compound (neonicotinoid) and a pyrethroid compound is disclosed in WO 2006/008614.

A synergistic insecticidal composition comprising a chloronicotinyl compound (neonicotinoid) and an organophosphorus compound is disclosed in WO 2006/008617.

A pesticidal composition comprising a) a pyrethroid selected from deltamethrin, fenvalerate, esfenvalerate, cyfluthrin, beta-cyfluthrin and bifenthrin, and b) an organophosphate insecticide selected from triazophos, profenofos, chlorpyrifos-methyl, monocrotofos, acephate, methamidophos and diethyl 1-phenyl-1 H-1 ,2,4-triazol-3-yl phosphate, the weight ratio of component a) to component b) being from 50:1 to 1:5 is disclosed in WO 2002/076213.

As disclosed in WO 2012/040802, there are reports of more than 24 species of mites throughout the world, including the two-spotted spider mite (Tetranychus urticae Koch). However, the two-spotted spider mite is the most harmful among those that exist in soybean crops. In the past, it was considered a minor pest, but today it has been causing serious damage to crops throughout Brazil, mainly in the states of Mato Grosso (MT) and Bahia (BA). General practice is to avoid spraying regular pyrethroids in the early stages of the crop cycle, due to mite imbalance.

It is an object of the present invention to provide, mixtures and compositions which, when applied at a reduced total amount of active compounds, have improved activity against the harmful pests and a broadened activity spectrum. It is a further object of the present invention to provide, mixtures and compositions which provide effective resistance management and insect pests control, at application rates which are as low as possible.

We have accordingly found that this may be achieved by mixtures and compositions, comprising a) a pyrethroid compound, b) a neonicotinoid compound and c) an organophosphate compound. Moreover, we have found that a combination of a) a pyrethroid compound, b) a neonicotinoid compound and c) an organophosphate compound being applied simultaneously, that is jointly or separately, or in succession allows better control of insect pests than is possible with the individual compounds alone, providing synergistic results.

The present invention, in addition to all the benefits of the mixture in pest control, also aims at preventing mite imbalance, an advantage that is lacking when using pyrethroids other than bifenthrin.

In light of the above, there is still a need for novel insecticidal compositions that exhibit synergistically enhanced action, a broader scope of activity and reduced cost of treatment.

It is therefore an objective of the present invention to provide a ternary insecticidal mixture which is both fast acting as well as long acting, with different modes of action, than those presently available.

### SUMMARY OF THE INVENTION

The present subject matter relates to a ternary insecticidal mixture that comprises as active components, a combination of a) a pyrethroid compound, b) a neonicotinoid compound and c) an organophosphate compound. In some embodiments, the pyrethroid compound is bifenthrin, the neonicotinoid compound is acetamiprid and the organophosphate compound is acephate.

The present subject matter also relates to a ternary insecticidal composition that comprises as active components, a combination of a) a pyrethroid compound, b) a neonicotinoid compound and c) an organophosphate compound.

The present subject matter also relates to a synergistic ternary insecticidal mixture that comprises as active components, a combination of a) a pyrethroid compound, b) a neonicotinoid compound and c) an organophosphate compound. In some embodiments, the pyrethroid compound is bifenthrin, the neonicotinoid compound is acetamiprid and the organophosphate compound is acephate.

The present subject matter also relates to a method for synergistic control of insects by contacting the insect or their food supply, habitat, breeding grounds or their locus with a synergistically effective amount of a combination of a) a pyrethroid compound, b) a neonicotinoid compound and c) an organophosphate compound.

The present subject matter also relates to a method of protecting plants from attack or infestation by insects comprising contacting the plant, or the soil or water in which the plant is growing, with a synergistically effective amount of a combination of a) a pyrethroid compound, b) a neonicotinoid compound and c) an organophosphate compound.

### DETAILED DESCRIPTION OF SPECIFIC EMBODIMENTS OF THE INVENTION

### Definitions

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter pertains.

As used herein the term “plant” or “crop” includes reference to whole plants, plant organs (e.g. leaves, stems, twigs, roots, trunks, limbs, shoots, fruits etc.), plant cells, or plant seeds. This term also encompasses plant crops such as fruits. The term “plant” may also include the propagation material thereof, which may include all the generative parts of the plant such as seeds and vegetative plant material such as cuttings and tubers, which can be used for the multiplication of the plant. It may also include spores, corms, bulbs, rhizomes, sprouts basal shoots, stolons, and buds and other parts of plants, including seedlings and young plants, which are to be transplanted after germination or after emergence from soil.

As used herein, the term “locus” includes a habitat, breeding ground, plant, propagation material, soil, area, material or environment in which a pest is growing or may grow.

As used herein, the terms “control” or “controlling” are meant to include, but are not limited to, any killing, growth regulating, inhibiting or interfering with the normal life cycle of the pest activities of a given pest. These terms include for example preventing larvae from developing into mature insects, modulating the emergence of pests from eggs including preventing eclosion, degrading the egg material, suffocation, reducing gut motility, inhibiting the formation of chitin, disrupting mating or sexual communication, and preventing feeding activity.

As used herein, the term “effective amount” refers to an amount of the mixture that, when ingested, contacted with or sensed, is sufficient to achieve a good level of control. It refers to the amount of the mixture necessary to kill an insect or otherwise deter the feeding of an insect from the source. When an insect comes into contact with an insecticidally effective amount of a composition, the results are typically death of the insect.

As used herein, the term “mixture” or “combination” refers, but is not limited to, a combination in any physical form, e.g., blend, solution, alloy, or the like.

As used herein, the term “cultivated plants” includes plants which have been modified by breeding, mutagenesis or genetic engineering. Genetically modified plants are plants, which genetic material has been modified by the use of recombinant DNA techniques. Typically, one or more genes have been integrated into the genetic material of such a plant in order to improve certain properties of the plant.

The term “plant health” comprises various sorts of improvements of plants that are not connected to the control of pests. For example, advantageous properties that may be mentioned are improved crop characteristics including: emergence, crop yields, protein content, oil content, starch content, more developed root system (improved root growth), improved stress tolerance (e.g. against drought, heat, salt, UV, water, cold), reduced ethylene (reduced production and/or inhibition of reception), increase in plant height, bigger leaf blade, less dead basal leaves, stronger tillers, greener leaf color, pigment content, photosynthetic activity, less input needed (such as fertilizers or water), less seeds needed, more productive tillers, earlier flowering, early grain maturity, less plant verse (lodging), increased shoot growth, enhanced plant vigor, increased plant stand and early and better germination; or any other advantages familiar to a person skilled in the art.

As used herein, the phrase “agriculturally acceptable carrier” means carriers which are known and accepted in the art for the formation of compositions for agricultural or horticultural use.

Throughout the application, descriptions of various embodiments use the term “comprising”; however, it will be understood by one of skill in the art, that in some specific instances, an embodiment can alternatively be described using the language “consisting essentially of” or “consisting of.”

The term “a” or “an” as used herein includes the singular and the plural, unless specifically stated otherwise. Therefore, the terms “a,” “an” or “at least one” can be used interchangeably in this application.

For purposes of better understanding the present teachings and in no way limiting the scope of the teachings, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques. In this regard, used of the term “about” herein specifically includes ±10% from the indicated values in the range. In addition, the endpoints of all ranges directed to the same component or property herein are inclusive of the endpoints, are independently combinable, and include all intermediate points and ranges.

### Insecticidal Mixture

It has been surprisingly found that by combining insecticides having different modes of action (MOA), i.e., systemic action, ingestion action and contact and stomach action, insecticidal mixtures are produced that exhibit a broad spectrum of control and high efficacy against very wide range of insects, as well as having a fast knock down and long residual effect under different climate conditions.

In some embodiments, the combination provides a higher insecticidal activity than that envisaged on the basis of the sum of activities of each of the insecticides found therein. Such a combination allows the reduced dosages of the individual insecticides which can damage agriculturally important plants.

Thus, an enhanced, synergistic insecticidal activity is observed when a ternary insecticidal composition that comprises a combination of a) a pyrethroid compound, b) a neonicotinoid compound and c) an organophosphate compound is used for the control of insects.

In an embodiment, the pyrethroid compound is allethrin, bifenthrin, cyfluthrin, beta-cyfluthrin, cyhalothrin, cyphenothrin, cypermethrin, alpha-cypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin, or a combination comprising at least one of the foregoing. In one representative embodiment, the pyrethroid compound is bifenthrin.

In another embodiment, the neonicotinoid compound is acetamiprid, clothianidin, dinotefuran, imidacloprid, nitenpyram, thiacloprid, thiamethoxam or a combination comprising at least one of the foregoing. In one representative embodiment, the neonicotinoid compound is acetamiprid.

In yet another embodiment, the organophosphate compound is selected from the group consisting of acephate, chlorpyrifos, diazinon, dimethoate, fenitrothion, malathion, methamidophos, monocrotophos, parathion-methyl, profenofos, terbufos, or a combination comprising at least one of the foregoing. In one representative embodiment, the organophosphate compound is acephate.

In some embodiments, the ternary insecticidal compositions comprise a combination of a) bifenthrin, b) a neonicotinoid compound and c) an organophosphate compound. Alternatively, the ternary insecticidal composition can comprise a combination of a) a pyrethroid compound, b) acetamiprid and c) an organophosphate compound. The ternary insecticidal composition can alternatively comprise a combination of a) a pyrethroid compound, b) a neonicotinoid compound and c) acephate. The ternary insecticidal composition can alternatively comprise a combination of a) a pyrethroid compound, b) acetamiprid and c) acephate. In yet another embodiment, the ternary insecticidal composition comprises a combination of a) bifenthrin, b) a neonicotinoid compound and c) acephate. In yet another embodiment, the ternary insecticidal composition comprises a combination of a) bifenthrin, b) acetamiprid and c) an organophosphate compound. In yet another embodiment, the ternary insecticidal composition comprises a combination of a) bifenthrin, b) acetamiprid and c) acephate.

The weight ratio of between the pyrethroid compound, the neonicotinoid compound and the organophosphate compound cannot generally be defined, as it varies depending upon various conditions such as the type of the formulation, weather conditions, the type of crop and the type of pests.

In one embodiment, the weight ratio of the pyrethroid compound to the neonicotinoid compound is from about 1:100 to 100:1. In another embodiment, the weight ratio of the pyrethroid compound to the neonicotinoid compound is from about 1:25 to 25:1. In yet another embodiment, the weight ratio of the pyrethroid compound to the neonicotinoid compound is from about 1:10 to 10:1. In a further embodiment, the weight ratio of the pyrethroid compound to the neonicotinoid compound is from about 1:2 to 2:1. In another embodiment, the weight ratio of the pyrethroid compound to the neonicotinoid compound is from about 1:1.

The weight ratio of the pyrethroid compound to the neonicotinoid compound may be an intermediate range selected from the above indicated ratios.

In one embodiment, the weight ratio of bifenthrin to acetamiprid is from about 1:100 to 100:1. In another embodiment, the weight ratio of bifenthrin to acetamiprid is from about 1:25 to 25:1. In yet another embodiment, the weight ratio of bifenthrin to acetamiprid is from about 1:10 to 10:1. In a further embodiment, the weight ratio of bifenthrin to acetamiprid is from about 1:2 to 2:1. In a particular embodiment, the weight ratio of bifenthrin to acetamiprid is from about 1:1.

In one embodiment, the weight ratio of the pyrethroid compound to the organophosphate compound is from about 1:100 to 100:1. In one embodiment, the weight ratio of the pyrethroid compound to the organophosphate compound is from about 1:75 to 75:1. In yet another embodiment, the weight ratio of the pyrethroid compound to the organophosphate compound is from about 1:50 to 50:1. In a further embodiment, the weight ratio of the pyrethroid compound to the organophosphate compound is from about 1:24 to 24:1.

The weight ratio of the pyrethroid compound to the organophosphate compound may be an intermediate range selected from the above indicated ratios.

In one embodiment, the weight ratio of bifenthrin to acephate is from about 1:100 to 100:1. In one embodiment, the weight ratio of bifenthrin to acephate is from about 1:75 to 75:1. In yet another embodiment, the weight ratio of bifenthrin to acephate is from about 1:50 to 50:1. In a further embodiment, the weight ratio of bifenthrin to acephate is from about 1:24 to 24:1.

In one embodiment, the weight ratio between the pyrethroid compound, the neonicotinoid compound and the organophosphate compound is from about 0.5-100:0.5-100:1-100. In one embodiment, the weight ratio between the pyrethroid compound, the neonicotinoid compound and the organophosphate compound is from about 0.5-50:0.5-50:1-50. In yet another embodiment, the weight ratio between the pyrethroid compound, the neonicotinoid compound and the organophosphate compound is from about 0.5-10:0.5-10:1-30. In a further embodiment, the weight ratio between the pyrethroid compound, the neonicotinoid compound and the organophosphate compound is from about 0.5-2:0.5-2:20-30. In a particular embodiment, the weight ratio between the pyrethroid compound, the neonicotinoid compound and the organophosphate compound is from about 1:1:24.

The weight ratio between the pyrethroid compound, the neonicotinoid compound and the organophosphate compound may be an intermediate range selected from the above indicated ratios.

In one embodiment, the weight ratio between bifenthrin, acetamiprid and acephate is from about 0.5-100:0.5-100:1-100. In one embodiment, the weight ratio between bifenthrin, acetamiprid and acephate is from about 0.5-50:0.5-50:1-50. In yet another embodiment, the weight ratio between bifenthrin, acetamiprid and acephate is from about 0.5-10:0.5-10:1-30. In a further embodiment, the weight ratio between bifenthrin, acetamiprid and acephate is from about 0.5-5:0.5-5:20-30. In a particular embodiment, the weight ratio bifenthrin, acetamiprid and acephate is from about 1:1:24.

In another embodiment, a method for control of insects by contacting the insect or their food supply, habitat, breeding grounds or their locus with a synergistically effective amount of a combination of a) a pyrethroid compound, b) a neonicotinoid compound and c) an organophosphate compound is provided.

For example, a method for control of insects by contacting the insect or their food supply, habitat, breeding grounds or their locus with a synergistically effective amount of a combination of a) bifenthrin, b) acetamiprid and c) acephate is provided.

In another embodiment, a method of protecting plants from attack or infestation by insects comprising contacting the plant, or the soil or water in which the plant is growing, with a synergistically effective amount of a combination of a) a pyrethroid compound, b) a neonicotinoid compound and c) an organophosphate compound is provided.

For example, a method of protecting plants from attack or infestation by insects comprising contacting the plant, or the soil or water in which the plant is growing, with a synergistically effective amount of a mixture of a) bifenthrin, b) acetamiprid and c) acephate is provided.

In yet another embodiment, the plants include vegetables, such as tomatoes, peppers, cabbage, broccoli, lettuce, spinach, cauliflower, melon, watermelon, cucumbers, carrots, onions and potatoes, tobacco, pome and stone fruits, such as walnuts, kiwi, berries, olive, almonds, pineapples, apples, pears, plums, peaches, and cherries, table and wine grapes, citrus fruit, such as oranges, lemons, grapefruits and limes, cotton, soybean, oil seed rape, wheat, barley, maize, sorghum, sunflower, peanuts, rice, pasture, coffee, beans, peas, yucca, sugar cane, clover and ornamentals such as roses.

In still another embodiment, the plants include cultivated plants which tolerate the action of herbicides, fungicides or insecticides as a result of breeding and/or genetically engineered methods.

In another embodiment, the insect pests are of the order Coleoptera, such as Acanthoscelides spp. (weevils), Acanthoscelides obtectus (common bean weevil), Agrilus planipennis (emerald ash borer), Agriotes spp. (wireworms), Anoplophora glabripennis (Asian longhorned beetle), Anthonomus spp. (weevils), Anthonomus grandis (boll weevil), Aphidius spp., Apion spp. (weevils), Apogonia spp. (grubs), Ataenius spretulus (Black Turgrass Ataenius), Atomaria linearis (pygmy mangold beetle), Aulacophore spp., Bothynoderes punctiventris (beet root weevil), Bruchus spp. (weevils), Bruchus pisorum (pea weevil), Cacoesia spp., Callosobruchus maculatus (southern cow pea weevil), Carpophilus hemipteras (dried fruit beetle), Cassida vittata, Cerosterna spp, Cerotoma spp. (chrysomeids), Cerotoma trifurcata (bean leaf beetle), Ceutorhynchus spp. (weevils), Ceutorhynchus assimilis (cabbage seedpod weevil), Ceutorhynchus napi (cabbage curculio), Chaetocnema spp. (chrysomelids), Colaspis spp. (soil beetles), Conoderus scalaris, Conoderus stigmosus, Conotrachelus nenuphar (plum curculio), Cotinus nitidis (Green June beetle), Crioceris asparagi (asparagus beetle), Cryptolestes ferrugineus (rusty grain beetle), Cryptolestes pusillus (flat grain beetle), Cryptolestes turcicus (Turkish grain beetle), Ctenicera spp. (wireworms), Curculio spp. (weevils), Cyclocephala spp. (grubs), Cylindrocpturus adspersus (sunflower stem weevil), Deporaus marginatus (mango leaf-cutting weevil), Dermestes lardarius (larder beetle), Dermestes maculates (hide beetle), Diabrotica spp. (chrysolemids), Epilachna varivestis (Mexican bean beetle), Faustinus cubae, Hylobius pales (pales weevil), Hypera spp. (weevils), Hypera postica (alfalfa weevil), Hyperdoes spp. (Hyperodes weevil), Hypothenemus hampei (coffee berry beetle), Ips spp. (engravers), Lasioderma serricorne (cigarette beetle), Leptinotarsa decemlineata (Colorado potato beetle), Liogenys futscus, Liogenys suturalis, Lissorhoptrus oryzophilus (rice water weevil), Lyctus spp. (wood beetles/powder post beetles), Maecolaspis joliveti, Megascelis spp., Melanotus communis, Meligethes spp., Meligethes aeneus (blossom beetle), Melolontha (common European cockchafer), Oberea brevis, Oberea linearis, Oryctes rhinoceros (date palm beetle), Oryzaephilus mercator (merchant grain beetle), Oryzaephilus surinamensis (sawtoothed grain beetle), Otiorhynchus spp. (weevils), Oulema melanopus (cereal leaf beetle), Oulema oryzae, Pantomorus spp. (weevils), Phyllophaga spp. (May/June beetle), Phyllophaga cuyabana, Phyllotreta spp. (chrysomelids), Phynchites spp., Popillia japonica (Japanese beetle), Prostephanus truncates (larger grain borer), Rhizopertha dominica (lesser grain borer), Rhizotrogus spp. (European chafer), Rhynchophorus spp. (weevils), Scolytus spp. (wood beetles), Shenophorus spp. (Billbug), Sitona lineatus (pea leaf weevil), Sitophilus spp. (grain weevils), Sitophilus granaries (granary weevil), Sitophilus oryzae (rice weevil), Stegobium paniceum (drugstore beetle), Tribolium spp. (flour beetles), Tribolium castaneum (red flour beetle), Tribolium confusum (confused flour beetle), Trogoderma variabile (warehouse beetle) and Zabrus tenebioides.

In yet another embodiment, the insect pests are of the order Diptera, such as Aedes spp. (mosquitoes), Agromyza frontella (alfalfa blotch leafminer), Agromyza spp. (leaf miner flies), Anastrepha spp. (fruit flies), Anastrepha suspensa (Caribbean fruit fly), Anopheles spp. (mosquitoes), Bactrocera spp. (fruit flies), Bactrocera cucurbitae (melon fly), Bactrocera dorsalis (oriental fruit fly), Ceratitis spp. (fruit flies), Ceratitis capitata (Mediterranea fruit fly), Chrysops spp. (deer flies), Cocliliomyia spp. (screwworms), Contarinia spp. (Gall midges), Culex spp. (mosquitoes), Dasineura spp. (gall midges), Dasineura brassicae (cabbage gall midge), Delia spp., Delia platura (seedcorn maggot), Drosophila spp. (vinegar flies), Fannia spp. (filth flies), Fannia canicularis (little house fly), Fannia scalaris (latrine fly), Gasterophilus intestinalis (horse bot fly), Gracillia perseae, Haematobia irritans (horn fly), Hylemyia spp. (root maggots), Hypoderma lineatum (common cattle grub), Liriomyza spp. (leafminer flies), Liriomyza brassica (serpentine leafminer), Melophagus ovinus (sheep ked), Musca spp. (muscid flies), Musca autumnalis (face fly), Musca domestica (house fly), Oestrus ovis (sheep bot fly), Oscinella frit (grass fly), Pegomyia betae (beet leafminer), Phorbia spp., Psila rosae (carrot rust fly), Rhagoletis cerasi (cherry fruit fly), Rhagoletis pomonella (apple maggot), Sitodiplosis mosellana (orange wheat blossom midge), Stomoxys calcitrans (stable fly), Tabanus spp. (horse flies) and Tipula spp. (crane flies).

In yet another embodiment, the insect pests are of the order Hemiptera, such as Acrosternum hilare (green stink bug), Blissus leucopterus (chinch bug), Calocoris norvegicus (potato mirid), Cimex hemipterus (tropical bed bug), Cimex lectularius (bed bug), Dagbertus fasciatus, Dichelops furcatus, Dysdercus suturellus (cotton stainer), Edessa meditabunda, Eurygaster maura (cereal bug), Euschistus heros, Euschistus servus (brown stink bug), Helopeltis antonii, Helopeltis theivora (tea blight plantbug), Lagynotomus spp. (stink bugs), Leptocorisa oratorius, Leptocorisa varicornis, Lygus spp. (plant bugs), Lygus hesperus (western tarnished plant bug), Maconellicoccus hirsutus, Neurocolpus longirostris, Nezara viridula (southern green stink bug), Paratrioza cockerelli, Phytocoris spp. (plant bugs), Phytocoris californicus, Phytocoris relativus, Piezodorus guildingi, Poecilocapsus lineatus (fourlined plant bug), Psallus vaccinicola, Pseudacysta perseae, Scaptocoris castanea and Triatoma spp. (bloodsucking conenose bugs/kissing bugs).

In yet another embodiment, the insect pests are of the order Homoptera, such as Acrythosiphon pisum (pea aphid), Adelges spp. (adelgids), Aleurodes proletella (cabbage whitefly), Aleurodicus disperses, Aleurothrixus floccosus (woolly whitefly), Aulacaspis spp., Amrasca biguttula, Aphrophora spp. (leafhoppers), Aonidiella aurantii (California red scale), Aphis spp. (aphids), Aphis gossypii (cotton aphid), Aphis pomi (apple aphid), Aulacorthum solani (foxglove aphid), Bemisia spp. (whiteflies), Bemisia argentifolii, Bemisia tabaci (sweetpotato whitefly), Brachycolus noxius (Russian aphid), Brachycorynella asparagi (asparagus aphid), Brevennia rehi, Brevicoryne brassicae (cabbage aphid), Ceroplastes spp. (scales), Ceroplastes rubens (red wax scale), Chionaspis spp. (scales), Chrysomphalus spp. (scales), Coccus spp. (scales), Dysaphis plantaginea (rosy apple aphid), Empoasca spp. (leafhoppers), Eriosoma lanigerum (woolly apple aphid), Icerya purchasi (cottony cushion scale), Idioscopus nitidulus (mango leafhopper), Laodelphax striatellus (smaller brown planthopper), Lepidosaphes spp., Macrosiphum spp., Macrosiphum euphorbiae (potato aphid), Macrosiphum granarium (English grain aphid), Macrosiphum rosae (rose aphid), Macrosteles quadrilineatus (aster leafhopper), Mahanarva frimbiolata, Metopolophium dirhodum (rose grain aphid), Mictis longicornis, Myzus persicae (green peach aphid), Nephotettix spp. (leafhoppers), Nephotettix cinctipes (green leafhopper), Nilaparvata lugens (brown planthopper), Parlatoria pergandii (chaff scale), Parlatoria ziziphi (ebony scale), Peregrinus maidis (corn delphacid), Philaenus spp. (spittlebugs), Phylloxera vitifoliae (grape phylloxera), Physokermes piceae (spruce bud scale), Planococcus spp. (mealybugs), Pseudococcus spp. (mealybugs), Pseudococcus brevipes (pine apple mealybug), Quadraspidiotus perniciosus (San Jose scale), Rhopalosiphum spp. (aphids), Rhopalosiphum maida (corn leaf aphid), Rhopalosiphum padi (oat bird-cherry aphid), Saissetia spp. (scales), Saissetia oleae (black scale), Schizaphis graminum (greenbug), Sitobion avenae (English grain aphid), Sogatella furcifera (white-backed planthopper), Therioaphis spp. (aphids), Toumeyella spp. (scales), Toxoptera spp. (aphids), Trialeurodes spp. (whiteflies), Trialeurodes vaporariorum (greenhouse whitefly), Trialeurodes abutiloneus (bandedwing whitefly), Unaspis spp. (scales), Unaspis yanonensis (arrowhead scale) and Zulia entreriana.

In yet another embodiment, the insect pests are of the order Lepidoptera, such as Achoea janata, Adoxophyes spp., Adoxophyes orana, Agrotis spp. (cutworms), Agrotis ipsilon (black cutworm), Alabama argillacea (cotton leafworm), Amorbia cuneana, Amyelosis transitella (navel orangeworm), Anacamptodes defectaria, Anarsia lineatella (peach twig borer), Anomis sabulifera (jute looper), Anticarsia gemmatalis (velvetbean caterpillar), Archips argyrospila (fruittree leafroller), Archips rosana (rose leaf roller), Argyrotaenia spp. (tortricid moths), Argyrotaenia citrana (orange tortrix), Autographa gamma, Bonagota cranaodes, Borbo cinnara (rice leaf folder), Bucculatrix thurberiella (cotton leafperforator), Caloptilia spp. (leaf miners), Capua reticulana, Carposina niponensis (peach fruit moth), Chilo spp., Chlumetia transversa (mango shoot borer), Choristoneura rosaceana (obliquebanded leafroller), Chrysodeixis spp., Cnaphalocerus medinalis (grass leafroller), Colias spp., Conopomorpha cramerella, Cossus (carpenter moth), Crambus spp. (Sod webworms), Cydia funebrana (plum fruit moth), Cydia molesta (oriental fruit moth), Cydia nignicana (pea moth), Cydia pomonella (codling moth), Darna diducta, Diaphania spp. (stem borers), Diatraea spp. (stalk borers), Diatraea saccharalis (sugarcane borer), Diatraea graniosella (southwester corn borer), Earias spp. (bollworms), Earias insulata (Egyptian bollworm), Earias vitella (rough northern bollworm), Ecdytopopha aurantianum, Elasmopalpus lignosellus (lesser cornstalk borer), Epiphysias postruttana (light brown apple moth), Ephestia spp. (flour moths), Ephestia cautella (almond moth), Ephestia elutella (tobbaco moth), Ephestia kuehniella (Mediterranean flour moth), Epimeces spp., Epinotia aporema, Erionota thrax (banana skipper), Eupoecilia ambiguella (grape berry moth), Euxoa auxiliaris (army cutworm), Feltia spp. (cutworms), Gortyna spp. (stemborers), Grapholita molesta (oriental fruit moth), Hedylepta indicata (bean leaf webber), Helicoverpa spp. (noctuid moths), Helicoverpa armigera (cotton bollworm), Helicoverpa zea (bollworm/corn earworm), Heliothis spp. (noctuid moths), Heliothis virescens (tobacco budworm), Hellula undalis (cabbage webworm), Indarbela spp. (root borers), Keiferia lycopersicella (tomato pinworm), Leucinodes orbonalis (eggplant fruit borer),Leucoptera malifoliella, Lithocollectis spp., Lobesia botrana (grape fruit moth), Loxagrotis spp. (noctuid moths), Loxagrotis albicosta (western bean cutworm), Lymantria dispar (gypsy moth), Lyonetia clerkella (apple leaf miner), Mahasena corbetti (oil palm bagworm), Malacosoma spp. (tent caterpillars), Mamestra brassicae (cabbage armyworm), Maruca testulalis (bean pod borer), Metisa plana (bagworm), Mythimna unipuncta (true armyworm), Neoleucinodes elegantalis (small tomato borer), Nymphula depunctalis (rice caseworm), Operophthera brumata (winter moth), Ostrinia nubilalis (European corn borer), Oxydia vesulia, Pandemis cerasana (common currant tortrix), Pandemis heparana (brown apple tortrix), Papilio demodocus, Pectinophora gossypiella (pink bollworm), Peridroma spp. (cutworms), Peridroma saucia (variegated cutworm), Perileucoptera coffeella (white coffee leafminer), Phthorimaea operculella (potato tuber moth), Phyllocnisitis citrella, Phyllonorycter spp. (leafminers), Pieris rapae (imported cabbageworm), Plathypena scabra, Plodia interpunctella (Indian meal moth), Plutella xylostella (diamondback moth), Polychrosis viteana (grape berry moth), Prays endocarpa, Prays oleae (olive moth), Pseudaletia spp. (noctuid moths), Pseudaletia unipunctata (armyworm), Pseudoplusia includens (soybean looper), Rachiplusia nu, Scirpophaga incertulas, Sesamia spp. (stemborers), Sesamia inferens (pink rice stem borer), Sesamia nonagrioides, Setora nitens, Sitotroga cerealella (Angoumois grain moth), Sparganothis pilleriana, Spodoptera spp. (armyworms), Spodoptera exigua (beet armyworm), Spodoptera fugiperda (fall armyworm), Spodoptera oridania (southern armyworm), Synanthedon spp. (root borers), Thecla basilides, Thermisia gemmatalis, Tineola bisselliella (webbing clothes moth), Trichoplusia ni (cabbage looper), Tuta absoluta, Yponomeuta spp., Zeuzera coffeae (red branch borer) and Zeuzera pyrina (leopard moth).

In yet another embodiment, the insect pests are of the order Orthoptera, such as Anabrus simplex (Mormon cricket), Gryllotalpidae (mole crickets), Locusta migratoria, Melanoplus spp. (grasshoppers), Microcentrum retinerve (angularwinged katydid), Pterophylla spp. (kaydids), chistocerca gregaria, Scudderia furcata (forktailed bush katydid) and Valanga nigricorni.

In yet another embodiment, the insect pests are of the order Thysanoptera, such as Frankliniella fusca (tobacco thrips), Frankliniella occidentalis (western flower thrips), Frankliniella shultzei Frankliniella williamsi (corn thrips), Heliothrips haemorrhoidalis (greenhouse thrips), Riphiphorothrips cruentatus, Scirtothrips spp., Scirtothrips citri (citrus thrips), Scirtothrips dorsalis (yellow tea thrips), Taeniothrips rhopalantennalis and Thrips spp.

Application of the inventive compositions to plants may also lead to an increase in the crop yield.

In an embodiment, the pyrethroid compound, the neonicotinoid compound and the organophosphate compound can be applied can be applied in the early stages of the crop cycle, such as for example pre-sowing or post-sowing of the crop. In a specific embodiment, a mixture of bifenthrin, acetamiprid and acephate can be applied can be applied in the early stages of the crop cycle due to the optimum balance of three active ingredients and the mitecide effect of bifenthrin.

In an embodiment, a mixture of bifenthrin, acetamiprid and acephate may be applied 40-60 DAT.

The effective application rates of the pyrethroid compound, the neonicotinoid compound and the organophosphate compound cannot generally be defined, as it varies depending upon various conditions such as the type of the formulation, weather conditions, the type of crop and the type of pests.

The application rates of the combination may vary, depending on the desired effect. In an embodiment, depending on the desired effect, the application rates of the mixture according to the invention are from 10 g/ha to 10000 g/ha, particularly from 50 to 5000 g/ha, more particularly from 100 to 2000 g/ha. In a particular example, the application rate of the mixture according to the invention is 800 g/ha.

Correspondingly, the application rates for the pyrethroid compound are generally from 1 to 250 g/ha, preferably from 10 to 200 g/ha, in particular from 20 to 100 g/ha.

Correspondingly, the application rates for the neonicotinoid compound are generally from 1 to 250 g/ha, preferably from 10 to 200 g/ha, in particular from 20 to 100 g/ha.

Correspondingly, the application rates for the organophosphate compound are generally from 1 to 2500 g/ha, preferably from 10 to 1500 g/ha, in particular from 600 to 1000 g/ha.

In another embodiment, the pyrethroid compound, the neonicotinoid compound and the organophosphate compound can be applied simultaneously, that is jointly or separately, or in succession, the sequence, in the case of separate application, generally not having any effect on the result of the control measures.

That is, each of the pyrethroid compound, the neonicotinoid compound and the organophosphate compound may be applied jointly or in succession. In one example, the pyrethroid compound, the neonicotinoid compound and the organophosphate compound are prepared separately, and the individual formulations are applied as is, or diluted to predetermined concentrations. In a further example, the pyrethroid compound, the neonicotinoid compound and the organophosphate compound are prepared separately, and the formulations are mixed when diluted to a predetermined concentration. In another example, the pyrethroid compound, the neonicotinoid compound and the organophosphate compound are formulated together, and the formulation is applied as it is, or the formulation is diluted to a predetermined concentration.

For example, bifenthrin, acetamiprid and acephate can be applied simultaneously, that is jointly or separately, or in succession, the sequence, in the case of separate application, generally not having any effect on the result of the control measures. In one example, bifenthrin, acetamiprid and acephate are prepared separately, and the individual formulations are applied as is, or diluted to predetermined concentrations. In a further example, bifenthrin, acetamiprid and acephate are prepared separately, and the formulations are mixed when diluted to a predetermined concentration. In another example, bifenthrin, acetamiprid and acephate are formulated together, and the formulation is applied as it is, or the formulation is diluted to a predetermined concentration.

In yet another embodiment, the synergistic composition may be applied in various mixtures or combinations of the pyrethroid compound, the neonicotinoid compound and the organophosphate compound, for example in a single “ready-for-use” form, or in a combined spray mixture composed from separate formulations of the single active ingredients, such as a “tank-mix” form.

In yet another embodiment, the composition is applied in the form of a ready-for-use formulation comprising the pyrethroid compound, the neonicotinoid compound and the organophosphate compound. This formulation can be obtained by combining the three active ingredients in an insecticidal effective amount with an agriculturally acceptable carrier, a surfactant or other application-promoting adjuvant customarily employed in formulation technology.

For example, the composition of the present invention is preferably applied in the form of a ready-for-use formulation comprising bifenthrin, acetamiprid and acephate, which can be obtained by combining the three active ingredients with an agriculturally acceptable carrier, a surfactant or other application-promoting adjuvant customarily employed in formulation technology.

The present composition may be employed or prepared in any conventional form, for example, as wettable powders (WP), emulsion concentrates (EC), microemulsion concentrates (MEC), water-soluble powders (SP), water-soluble concentrates (SL), suspoemulsion (SE), oil dispersions (OD), concentrated emulsions (BW) such as oil-in-water and water-in-oil emulsions, sprayable solutions or emulsions, capsule suspensions (CS), suspension concentrates (SC), suspension concentrates, dusts (DP), oil-miscible solutions (OL), seed-dressing products, granules (GR) in the form of microgranules, spray granules, coated granules and absorption granules, granules for soil application or broadcasting, water-soluble granules (SG), water-dispersible granules (WDG), ULV formulations, microcapsules or waxes. These individual formulation types are known in the art.

According to an embodiment, the composition comprises at least one additional component selected from the group of surfactants, solid diluents and liquid diluents.

Such compositions can be formulated using agriculturally acceptable carriers, surfactants or other application-promoting adjuvants customarily employed in formulation technology and formulation techniques that are known in the art.

Examples of suitable liquid carriers potentially useful in the present compositions include but are not limited to water; aromatic hydrocarbons such as alkylbenzenes and alkylnaphthalenes; alcohols such as cyclohexanol, and decanol; ethylene glycol; polypropylene glycol;

dipropropylene glycol; N,N-dimethylformamide; dimethylsulfoxide; dimethylacetamide; N-alkylpyrrolidones such as N-methyl-2-pyrrolidone; paraffins; various oils such as olive, castor, linseed, tung, sesame, corn, peanut, cotton-seed, soybean, rape-seed, or coconut oil; fatty acid esters; ketones such as cyclohexanone, 2-heptanone, isophorone, and 4-hydroxy-4-methyl-2-pentanone; and the like.

Examples of suitable solid carriers potentially useful in the present compositions include but are not limited to mineral earths such as silica gels, silicates, talc, kaolin, sericite, attaclay, limestone, bentonite, lime, chalk, bole, mirabilite, loess, clay, dolomite, zeolite, diatomaceous earth, calcium carbonate, calcium sulfate, magnesium sulfate, magnesium oxide, sodium carbonate and bicarbonate, and sodium sulfate; ground synthetic materials; fertilizers such as ammonium sulfate, ammonium phosphate, ammonium nitrate, ureas, and products of vegetable origin, such as cereal meal, tree bark meal, wood meal, and nutshell meal; cellulose powders; and other solid carriers.

Examples of suitable surfactants include, but are not limited to, non-ionic, anionic, cationic and ampholytic types such as alkoxylated fatty alcohols, ethoxylated polysorbate (e.g. tween 20), ethoxylated castor oil, lignin sulfonates, fatty acid sulfonates (e.g. lauryl sulfonate), phosphate esters such as phosphate esters of alcohol alkoxylates, phosphate esters of alkylphenol alkoxylates and phosphate esters of styrylphenol ethoxylates, condensates of sulfonated naphthalene and naphthalene derivatives with formaldehyde, condensates of naphthalene or of naphthalenesulfonic acid with phenol and formaldehyde, alkylarylsulfonates, ethoxylated alkylphenols and aryl phenols, polyalkylene glycols, sorbitol esters, alkali metal, sodium salts of lignosulphonates, tristyrylphenol ethoxylate phosphate esters, aliphatic alcohol ethoxylates, alkylphenol ethoxylates, ethylene oxide/propylene oxide block copolymers, graft copolymers and polyvinyl alcohol-vinyl acetate copolymers. Other surfactants known in the art may be used as desired.

Other ingredients, such as wetting agents, anti-foaming, adhesives, neutralizers, thickeners, binders, sequestrates, fertilizers, biocides, stabilizers, buffers or anti-freeze agents, may also be added to the present compositions in order to increase the stability, density, and viscosity of the described compositions.

Aqueous use forms can be prepared from emulsion concentrates, suspensions, pastes, wettable powders or water-dispersible granules by adding water. To prepare emulsions, pastes or oil dispersions, the components of the compositions either as such or dissolved in an oil or solvent, can be homogenized in water by means of a wetting agent, tackifier, dispersant or emulsifier. Alternatively, it is also possible to prepare concentrates comprising active ingredient, wetting agent, tackifier, dispersant or emulsifier and, if desired, a solvent or oil, which are suitable for dilution with water.

In an embodiment, the amount of the mixture of active ingredients in the composition is from about 0.1%, 0.5%, 1%, 1.5%, 2%, 2.5%, 3%, 3.5%, 4%, 4.5%, 5% to about 90%, 93%, 95%, 98%, 99% based on the total weight of the composition.

In another embodiment, the combined amount of the pyrethroid compound, the neonicotinoid compound and the organophosphate compound together in the ready-to-use formulations is 1-95 wt. %, particularly 75-95 wt. %, based on the total weight of the formulation.

For example, the combined amount of bifenthrin, acetamiprid and acephate in the ready-to-use formulations according to the invention is 1-95 wt. %, particularly 75-95 wt. %, more particularly is 80-90 wt. %, based on the total weight of the formulation.

The present composition may include additional crop protection agents, for example insecticides, herbicides, fungicides, bactericides, nematicides, molluscicides, growth regulators, biological agents, biostimulants, fertilizers, or mixtures thereof. However, for the avoidance of doubt it is understood that such additional crop protection agents are unnecessary to achieve the desired control of pests as achieved by the present combinations. Accordingly, the present insecticidal compositions and mixtures may be limited to containing acephate, acetamiprid and bifenthrin, as the only crop protection agents present.

In another embodiment, the present invention provides a kit comprising a ternary synergistic insecticidal composition as described herein, or components thereof. Such kits may comprise, in addition to the aforementioned active components, one or more additional active and/or inactive ingredients, either within the provided insecticidal composition or separately. Certain kits comprise a) a pyrethroid compound, b) a neonicotinoid compound and c) an organophosphate compound, each in a separate container, and each optionally combined with a carrier.

As noted above, the compositions, kits and methods described herein exhibit a synergistic effect. A synergistic effect exists wherever the action of a combination of active components is greater than the sum of the action of each of the components alone. Therefore, a synergistically effective amount (or an effective amount of a synergistic composition or combination) is an amount that exhibits greater insecticidal activity than the sum of the insecticidal activities of the individual components.

The following examples illustrate the practice of the present invention in some of its embodiments, but should not be construed as limiting the scope of the invention. Other embodiments will be apparent to one skilled in the art from consideration of the specification and examples. It is intended that the specification, including the examples, is considered exemplary only without limiting the scope and spirit of the invention.

### BIOLOGICAL EXAMPLES

A synergistic effect exists whenever the action of an active ingredient combination is greater than the sum of the actions of the individual components.

In the field of agriculture, it is often understood that the term “synergy” is as defined by Colby S. R. in an article entitled “Calculation of the synergistic and antagonistic responses of herbicide combinations” published in the journal Weeds, 1967, 15, p. 20-22. The action expected for a given combination of two active components can be calculated as follows:

$$E = X + Y - \frac{XY}{100}$$

The action expected for a given combination of three active components can be calculated as follows:

$$E = X + Y + Z - \frac{XY + XZ + YZ}{100} + \frac{XYZ}{10000}$$

in which E represents the expected percentage of insecticidal control for the combination of the three insecticides at defined doses (for example equal to x, y and z respectively), X is the percentage of insecticidal control observed by the compound (I) at a defined dose (equal to x), Y is the percentage of insecticidal control observed by the compound (II) at a defined dose (equal to y), Z is the percentage of insecticidal control observed by the compound (III) at a defined dose (equal to z). When the percentage of insecticidal control observed for the combination is greater than the expected percentage, there is a synergistic effect.

Experiments were carried out to determine the synergistic insecticidal effect of the ternary insecticidal composition which comprises a mixture of a) bifenthrin, b) acetamiprid and c) acephate.

### EXAMPLE 1

An experiment was conducted to evaluate the insecticidal control of the brown stink bug (Euschistus heros) with a pyrethroid compound (bifenthrin), a neonicotinoid compound (acetamiprid) and an organophosphate compound (acephate), alone, in binary mixtures and in ternary mixtures.

The experiments were conducted by applying commercially available compositions of bifenthrin (Seizer 10 EC), acetamiprid (Yovel 20 SP) and acephate (Absolut 97 SG) alone or together at different concentrations. The compositions were diluted with water to the stated concentration of the active compound.

The following active ingredients and their mixtures were evaluated:
acephate 68 gr (A.I.)/ha
acephate 170 gr (A.I.)/ha
bifenthrin 2.8 gr (A.I.)/ha
bifenthrin 7 gr (A.I.)/ha
acetamiprid 16 gr (A.I.)/ha
acetamiprid 40 gr (A.I.)/ha
acephate+bifenthrin 68 gr (A.I.)/ha+2.8 gr (A.I.)/ha
acephate+bifenthrin 170 gr (A.I.)/ha+7 gr (A.I.)/ha
acetamiprid+bifenthrin 16 gr (A.I.)/ha+2.8 gr (A.I.)/ha
acetamiprid+bifenthrin 40 gr (A.I.)/ha+7 gr (A.I.)/ha
acetamiprid+acephate 16 gr (A.I.)/ha+68 gr (A.I.)/ha
acetamiprid+acephate 40 gr (A.I.)/ha+170 gr (A.I.)/ha
acephate+acetamiprid+bifenthrin 68 gr (A.I.)/ha+16 gr (A.I.)/ha+2.8 gr (A.I.)/ha
acephate+acetamiprid+bifenthrin 170 gr (A.I.)/ha+40 gr (A.I.)/ha+7 gr (A.I.)/ha

The treatments were composed of 6 replicates, where each treatment was performed in a gerbox. The application of insecticides was carried out with the aid of a CO2 pressurized costal sprayer. The gerbox boxes were placed without the covers on the floor and sprayed. A bean pod was placed in each box to feed the insects. 10 adult insects (Euschistus heros) were placed in each box.

Evaluations were performed at 3 hours, 8, hours, 1 day, 2 days and 3 days after infestation. At these times the number of alive and dead insects in each box were counted.

Tables 1-2 below summarize the calculated Colby ratio for the triple mixture at each of the evaluation periods.

TABLE 1

| | 3 Hours after | 8 Hours after | 1 day after | 2 days after | 3 days after |
|---|---|---|---|---|---|
| | application | application | application | application | application |
| acephate + acetamiprid + bifenthrin | 1.63 | 1.50 | 1.42 | 1.16 | 1.28 |
| 68 gr (A.I.)/ha + 16 gr (A.I.)/ha + | | | | | |
| 2.8 gr (A.I.)/ha | | | | | |

TABLE 2

| | 2 days after | 3 days after |
|---|---|---|
| | application | application |
| acephate + acetamiprid + bifenthrin | 1.30 | 1.44 |
| 170 gr (A.I.)/ha + 40 gr (A.I.)/ha + | | |
| 7 gr (A.I.)/ha | | |

### Example 2

An experiment was conducted to evaluate the insecticidal control of whitefly (Bemisia tabaci) with a pyrethroid compound (bifenthrin), a neonicotinoid compound (acetamiprid) and an organophosphate compound (acephate), alone, in binary mixtures and in ternary mixtures.

The experiments were conducted by applying commercially available compositions of bifenthrin (Seizer 10 EC), acetamiprid (Yovel 20 SP) and acephate (Absolut 97 SG) alone or together at different concentrations. The compositions were diluted with water to the stated concentration of the active compound.

The active ingredients and their mixtures which were evaluated in Example 1, were evaluated in this example.

The experiments were performed on adult insects (Bemisia tabaci). Evaluations were performed at 3 hours. At this time the number of alive and dead insects in each box were counted. Table 3 below summarize the calculated Colby ratio for the triple mixture at each of the evaluation periods.

TABLE 3

| | 3 hours after |
|---|---|
| | application |
| acephate + acetamiprid + bifenthrin | 1.80 |
| 68 gr (A.I.)/ha + 16 gr (A.I.)/ha + | |
| 2.8 gr (A.I.)/ha | |
| acephate + acetamiprid + bifenthrin | 1.50 |
| 170 gr (A.I.)/ha + 40 gr (A.I.)/ha + | |
| 7 gr (A.I.)/ha | |

To calculate the efficiency percentage of the insecticides, the following equation was used:

$$E ( \% ) = 100 X \frac{( 1 - N 1 \times N 2 )}{N 3 \times N 4}$$

E (%): percentage of efficiency (control);
N1=number of insects in the control before application;
N2=number of insects in treatment after application;
N3=number of insects in the control after application;
N4=number of insects in treatment before application.

The expected percent of control was determined using the method of Colby S. R. as discussed above, and the Colby ratio (observed average / expected average) was calculated. When the percentage of insecticidal control observed for the combination is greater than the expected percentage (i.e., the Colby ratio is greater than 1), there is a synergistic effect.

Based on the results presented hereinabove, the ternary insecticidal composition which comprises a combination of a) a pyrethroid compound, b) a neonicotinoid compound and c) an organophosphate compound, specifically of bifenthrin, acetamiprid and acephate was found to exhibit strong synergistic effects against insects such as brown stink bugs and whiteflies. Such combinations are suitable for controlling of insects in a plant or in the environment in which such a plant is grown or stored, such as soil, storage containers, etc.

While the present invention has been shown and described with reference to preferred embodiments thereof, it will be understood by those skilled in the art that many alternatives, modifications and variations may be made thereto without departing from the spirit and scope thereof. Accordingly, it is intended to embrace all such alternatives, modifications, and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference.

In addition, any priority document(s) of this application is/are hereby incorporated herein by reference in its/their entirety.

What is claimed is:

1. A ternary insecticidal mixture comprising, as active components a) a pyrethroid compound; b) a neonicotinoid compound; and c) an organophosphate compound.

2. The mixture of claim 1, wherein said pyrethroid compound is allethrin, bifenthrin, cyfluthrin, beta-cyfluthrin, cyhalothrin, cyphenothrin, cypermethrin, alpha-cypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin or a combination comprising at least one of the foregoing.

3. The mixture of claim 2, wherein said pyrethroid compound is bifenthrin.

4. The mixture of any one of claims 1-3, wherein said neonicotinoid compound is selected from the group consisting of acetamiprid, clothianidin, dinotefuran, imidacloprid, nitenpyram, thiacloprid, thiamethoxam or a combination comprising at least one of the foregoing.

5. The mixture of claim 4, wherein said neonicotinoid compound is acetamiprid.

6. The mixture of any one of claims 1-5, wherein said organophosphate compound is selected from the group consisting of acephate, chlorpyrifos, diazinon, dimethoate, fenitrothion, malathion, methamidophos, monocrotophos, parathion-methyl, profenofos, terbufos, or a combination comprising at least one of the foregoing.

7. The mixture of claim 6, wherein said organophosphate compound is acephate.

8. The mixture of any one of claims 1-7, wherein the weight ratio of the pyrethroid compound and the neonicotinoid compound is from 1:100 to 100:1.

9. The mixture of any one of claims 1-8, wherein the weight ratio of the pyrethroid compound and the organophosphate compound is from 1:100 to 100:1.

10. The mixture of any one of claims 1-9, wherein the weight ratio of the pyrethroid compound, the neonicotinoid compound, and the organophosphate compound in a weight ratio of from 1-100:1-100:1-100.

11. The mixture of claim 10, wherein the weight ratio of the pyrethroid compound, the neonicotinoid compound, and the organophosphate compound in a weight ratio of from 1:1:24.

12. The mixture of any one of claims 1-11, wherein the mixture provides a synergistic effect.

13. The mixture of any one of claims 1-12, wherein the pyrethroid compound, the neonicotinoid compound, and the organophosphate compound are applied jointly or in a succession.

14. The mixture of any one of claims 1-13, wherein said mixture is used to provide a rate of application of from 0.1 to 10 kg/ha.

15. The mixture of claim 14, wherein said mixture is used to provide a rate of application of from 0.1 to 2 kg/ha.

16. A ternary insecticidal composition comprising, as active components a) a pyrethroid compound; b) a neonicotinoid compound; and c) an organophosphate compound.

17. The composition of claim 16, characterized in that it further comprises an agriculturally acceptable carrier.

18. The composition of claim 16 or 17, further comprising at least one surfactant, solid diluent, liquid diluent, or a combination thereof

19. The composition of any one of claims 16-18, wherein said pyrethroid compound is allethrin, bifenthrin, cyfluthrin, beta-cyfluthrin, cyhalothrin, cyphenothrin, cypermethrin, alpha-cypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin or a combination comprising at least one of the foregoing.

20. The composition of claim 19, wherein said pyrethroid compound is bifenthrin.

21. The composition of any one of claims 16-20, wherein said neonicotinoid compound is selected from the group consisting of acetamiprid, clothianidin, dinotefuran, imidacloprid, nitenpyram, thiacloprid, thiamethoxam or a combination comprising at least one of the foregoing.

22. The composition of claim 21, wherein said neonicotinoid compound is acetamiprid.

23. The composition of any one of claims 16-22, wherein said organophosphate compound is selected from the group consisting of acephate, chlorpyrifos, diazinon, dimethoate, fenitrothion, malathion, methamidophos, monocrotophos, parathion-methyl, profenofos, terbufos, or a combination comprising at least one of the foregoing.

24. The composition of claim 23, wherein said organophosphate compound is acephate.

25. The composition of any one of claims 16-24, comprising the pyrethroid compound and the neonicotinoid compound in a weight ratio of from 1:100 to 100:1.

26. The composition of any one of claims 16-25, comprising the pyrethroid compound and the organophosphate compound in a weight ratio of from 1:100 to 100:1.

27. The composition of any one of claims 16-26, wherein the weight ratio of the pyrethroid compound, the neonicotinoid compound, and the organophosphate compound in a weight ratio of from 1-100:1-100:1-100.

28. The composition of claim 27, wherein the weight ratio of the pyrethroid compound, the neonicotinoid compound, and the organophosphate compound in a weight ratio of from 1:1:24.

29. The composition of any one of claims 16-28, wherein the pyrethroid compound, neonicotinoid compound and the organophosphate compound are present in a combined amount ranging from 5% to 80% by weight of the total weight of all components in the composition.

30. The composition of any one of claims 16-29, wherein the composition provides a synergistic effect.

31. The composition of any one of claims 16-30, wherein said composition is used to provide a rate of application of from 0.1 to 10 kg/ha.

32. The composition of claim 31, wherein said composition is used to provide a rate of application of from 0.1 to 2 kg/ha.

33. A synergistic ternary insecticidal mixture comprising, as active components a) a pyrethroid compound; b) a neonicotinoid compound; and c) an organophosphate compound.

34. The mixture of claim 33, wherein said pyrethroid compound is allethrin, bifenthrin, cyfluthrin, beta-cyfluthrin, cyhalothrin, cyphenothrin, cypermethrin, alpha-cypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin or a combination comprising at least one of the foregoing.

35. The mixture of claim 34, wherein said pyrethroid compound is bifenthrin.

36. The mixture of any one of claims 33-35, wherein said neonicotinoid compound is selected from the group consisting of acetamiprid, clothianidin, dinotefuran, imidacloprid, nitenpyram, thiacloprid, thiamethoxam or a combination comprising at least one of the foregoing.

37. The mixture of claim 36, wherein said neonicotinoid compound is acetamiprid.

38. The mixture of any one of claims 33-37, wherein said organophosphate compound is selected from the group consisting of acephate, chlorpyrifos, diazinon, dimethoate, fenitrothion, malathion, methamidophos, monocrotophos, parathion-methyl, profenofos, terbufos, or a combination comprising at least one of the foregoing.

39. The mixture of claim 38, wherein said organophosphate compound is acephate.

40. The mixture of any one of claims 33-39, wherein the weight ratio of the pyrethroid compound and the neonicotinoid compound is from 1:100 to 100:1.

41. The mixture of any one of claims 33-40, wherein the weight ratio of the pyrethroid compound and the organophosphate compound is from 1:100 to 100:1.

42. The mixture of any one of claims 33-41, wherein the weight ratio of the pyrethroid compound, the neonicotinoid compound, and the organophosphate compound in a weight ratio of from 1-100:1-100:1-100.

43. The mixture of claim 42, wherein the weight ratio of the pyrethroid compound, the neonicotinoid compound, and the organophosphate compound in a weight ratio of from 1:1:24.

44. The mixture of any one of claims 33-43, wherein the pyrethroid compound, the neonicotinoid compound, and the organophosphate compound are applied jointly or in a succession.

45. The mixture of any one of claims 33-44, wherein said mixture is used to provide a rate of application of from 0.1 to 10 kg/ha.

46. The mixture of claim 45, wherein said mixture is used to provide a rate of application of from 0.1 to 2 kg/ha.

47. A synergistic ternary insecticidal composition comprising, as active components a) a pyrethroid compound; b) a neonicotinoid compound; and c) an organophosphate compound.

48. The composition of claim 47, characterized in that it further comprises an agriculturally acceptable carrier.

49. The composition of claim 47 or 48, further comprising at least one surfactant, solid diluent, liquid diluent, or a combination thereof

50. The composition of any one of claims 47-49, wherein said pyrethroid compound is allethrin, bifenthrin, cyfluthrin, beta-cyfluthrin, cyhalothrin, cyphenothrin, cypermethrin, alpha-cypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin or a combination comprising at least one of the foregoing.

51. The composition of claim 50, wherein said pyrethroid compound is bifenthrin.

52. The composition of any one of claims 47-51, wherein said neonicotinoid compound is selected from the group consisting of acetamiprid, clothianidin, dinotefuran, imidacloprid, nitenpyram, thiacloprid, thiamethoxam or a combination comprising at least one of the foregoing.

53. The composition of claim 52, wherein said neonicotinoid compound is acetamiprid.

54. The composition of any one of claims 47-53, wherein said organophosphate compound is selected from the group consisting of acephate, chlorpyrifos, diazinon, dimethoate, fenitrothion, malathion, methamidophos, monocrotophos, parathion-methyl, profenofos, terbufos, or a combination comprising at least one of the foregoing.

55. The composition of claim 54, wherein said organophosphate compound is acephate.

56. The composition of any one of claims 47-55, comprising the pyrethroid compound and the neonicotinoid compound in a weight ratio of from 1:100 to 100:1.

57. The composition of any one of claims 47-56, comprising the pyrethroid compound and the organophosphate compound in a weight ratio of from 1:100 to 100:1.

58. The composition of any one of claims 47-57, wherein the weight ratio of the pyrethroid compound, the neonicotinoid compound, and the organophosphate compound in a weight ratio of from 1-100:1-100:1-100.

59. The composition of claim 58, wherein the weight ratio of the pyrethroid compound, the neonicotinoid compound, and the organophosphate compound in a weight ratio of from 1:1:24.

60. The composition of any one of claims 47-59, wherein the pyrethroid compound, neonicotinoid compound and the organophosphate compound are present in a combined amount ranging from 5% to 80% by weight of the total weight of all components in the composition.

61. The composition of any one of claims 47-60, wherein said composition is used to provide a rate of application of from 0.1 to 10 kg/ha.

62. The composition of claim 61, wherein said composition is used to provide a rate of application of from 0.1 to 2 kg/ha.

63. A method for control of insects, comprising contacting the insects or their food supply, habitat, breeding grounds or their locus with a mixture of any one of claim 1-15 or 33-46, or a composition of any one of claim 16-32 or 47-62.

64. A method for control of insects, comprising contacting the insects or their food supply, habitat, breeding grounds or their locus with a synergistically effective amount of a mixture of a) a pyrethroid compound; b) a neonicotinoid compound; and c) an organophosphate compound.

65. A method for control of insects, comprising contacting the insect or their food supply, habitat, breeding grounds or their locus with a synergistically effective amount of a mixture of a) bifenthrin; b) acetamiprid; and c) acephate.

66. The method of claim 64 or 65, wherein said mixture is applied in an amount of from 0.1 to 10 kg/ha.

67. The method of claim 66, wherein said mixture is applied in an amount of from 0.1 to 2 kg/ha.
